(19) United States
(12) Patent Application Publication
(10) Pub. No.: US 2007/0080184 A1
(43) Pub. Date: Apr. 12, 2007

(54) Car seat transport device and method

(76) Inventors: Perry Cowen, Maple Grove, MN (US); Shaun Flandrick, Maple Grove, MN (US); Stacie Cowen, Maple Grove, MN (US); Laura Flandrick, Maple Grove, MN (US)

Correspondence Address: Bell, Boyd & Lloyd LLC, P.O. Box 1135, Chicago, IL, 60690-1135, US

(21) Appl. No.: 11/245,587

(22) Filed: Oct. 7, 2005

(51) Int. Cl. A61G 1/00; A45F 3/08

(52) U.S. Cl. 224/160; 224/262

(57) ABSTRACT

The present disclosure provides a compact, lightweight, foldable, easy to use, low cost, portable car seat transport device and method of using the same. The car seat transport device may be adapted to carry any type of car seat. The device includes a harness having a lower strap and an upper strap, each strap having respective first and second ends. The lower strap may be adapted to extend through a lower slot in the car seat and the upper strap may be adapted to extend through an upper slot of the car seat. The upper strap may be attached to the lower strap and the first and second ends of the lower strap may be attached to each other. The harness may be a single piece with the upper strap being fixedly attached to the lower strap. The car seat transport device provides a remarkably easy to use and effective support system that permits hands-free carriage of the car seat from a person's body.

### BACKGROUND

Car seats are a commonly known safety device used to protect infants and small children in vehicles during transit. Car seats typically have a hard outer shell of a rigid polymeric material molded to surround the car sear resident on three sides, the interior of which is lined with padding. The padding may be formed or contoured to accommodate the child's head, neck, and body for increased impact protection. Cars seats also typically include two or more upper slots through which safety straps extend. The safety straps are extended over the child's shoulders and torso and are releasably secured to the car seat in order to immobilize the child during transit, similar to car seat belts, for example. Conventional car seats also include lower slots through which a vehicle strap (i.e., a car seat belt) may extend to secure the car seat to the vehicle.

Advantages of conventional car seats include adaptability and portability. Car seats may be readily removed and installed between different cars, trucks, or minivans. Many car seats are modular and are adapted to fit into stroller-type apparatuses. Indeed, car seats are commonly used to transport small children in airplane, bus, and train seats. Car seats, however, have their practical limitations, particularly when it is desired to carry the car seat from the car to a different location. Car seats, by nature are unwieldy, awkward and difficult to handle due to their protective function. A single trek through a transportation terminal (such as an airport) is more than enough for one to appreciate the difficulty, frustration, and challenge involved with carrying the car seat, managing the child's travel necessities (i.e., diaper bag, toys, food), supervising the child, and negotiating the crowd.

Previous attempts at overcoming the difficulties involved in carrying a car seat are lacking. Travel bag devices that encase the car seat are cumbersome to carry. Rigid backpack type carrying devices and/or wheeled pull-cart car seat carrying devices are bulky and only increase the number of equipment pieces for which the already overburdened traveling parent or child caretaker must account. A need therefore exists for a hands-free and compact car seat transport device that is lightweight and easy to use.

### SUMMARY

The present disclosure provides a compact, lightweight, foldable, easy to use, portable car seat transport device adapted to carry any type of car seat. The device includes a harness having a lower strap and an upper strap, each strap having respective first and second ends. The lower strap may be adapted to extend through a lower slot in the car seat and the upper strap may be adapted to extend through an upper slot of the car seat. The upper strap may be attachable to the lower strap and the first and second ends of the lower strap may be attachable to each other. In an embodiment, the harness may be a single piece with an end of the upper strap being fixedly attached to the lower strap. The car seat transport device of the present disclosure thereby provides an innovative and simple, low cost support system that permits hands-free carriage of the car seat from a person's body.

In an embodiment, the lower strap may be extended around a person's waist and the upper strap may be extended over a shoulder of a person. The first lower strap end may be releasably attachable to the second lower strap end. This enables the car seat to be supported with the device from a person's back, chest, or side.

In an embodiment, the lower strap may be adapted to extend through a second lower slot of the car seat. The upper strap may be adapted to extend through a second upper slot of the car seat. In a further embodiment, the upper strap may extend over a first shoulder and a second shoulder of a person. Any of these arrangements may advantageously provide additional stability to the car seat and/or additional comfort to the person carrying the car seat when using the car seat transport device to support the car seat from the person's body.

In a further embodiment, a car seat transport device is provided that includes a harness with a lower strap and an upper strap, each strap having respective first and second ends. The first end of the upper strap may be weaved through a first upper slot and a second upper slot of the car seat. The first and second ends of the upper strap may be attachable to the lower strap and the first and second ends of the lower strap may be attachable to each other.

In an embodiment, the upper strap may extend over the shoulders of a person so that harness supports the car seat from the person's body. The car seat may be supported by the harness from the person's back, the person's chest, or the person's side. In an embodiment, the lower strap may extend around the waist of a person and may or may not extend through a lower slot in of the car seat.

The present disclosure also provides a method for transporting a car seat. The method includes providing a harness having a lower strap and an upper strap, each strap having respective first and second ends. The method entails extending the first end of the upper strap through an upper slot of the car seat and over a person's shoulder, extending the lower strap around the person's waist, attaching the first and second ends of the upper strap to the lower strap, attaching the first and second ends of the lower strap to each other, and supporting with the straps the car seat from the person's body. The method may further include suspending with the straps the car seat from the back of the person, the chest of the person, or the side of the person.

In an embodiment, the method may include extending an end of the lower strap through a lower slot of the car seat. This may advantageously provide more stability and support when the car seat is supported with the harness from the person's back.

In an embodiment, the method may include weaving the first end of the upper strap through a second upper slot of the car seat and extending the upper strap over a second shoulder of the person. The first end of the upper strap may be extended over an upper portion of the car seat. The weaving advantageously secures the car seat to the upper strap and the harness. The weaving of the upper strap advantageously provides a simple, low cost, and easy method by which to secure the car seat to harness and permits hands-free support of the car seat from the person's body with minimal equipment.

Additional features and advantages are described herein, and will be apparent from, the following Detailed Description and the Figures.

### BRIEF DESCRIPTION OF THE FIGURES

FIG. 1 is a perspective view of a car seat transport device in accordance with the present disclosure.

FIG. 2 is a perspective view of a car seat transport device configured about a car seat in accordance with an embodiment of the present disclosure.

FIG. 3 is a perspective view of a car seat transport device configured about a car seat in accordance with an embodiment of the present disclosure.

FIG. 4 is a perspective view of a car seat transport device configured about a car seat in accordance with an embodiment of the present disclosure.

FIG. 5 is a perspective view of a car seat transport device configured about a car seat in accordance with an embodiment of the present disclosure.

FIG. 6 is a perspective view of a car seat transport device configured about a car seat in accordance with an embodiment of the present disclosure.

FIG. 7 is a perspective view of a car seat transport device configured about a car seat in accordance with an embodiment of the present disclosure.

FIG. 8 is a perspective view of a car seat transport device configured about a car seat in accordance with an embodiment of the present disclosure.

FIG. 9 is a perspective view of a person carrying a car seat with the car seat transport device in accordance with an embodiment of the disclosure.

FIG. 10 is a perspective view of the car seat transport device in a stowed configuration in accordance with an embodiment of the present disclosure.

### DETAILED DESCRIPTION

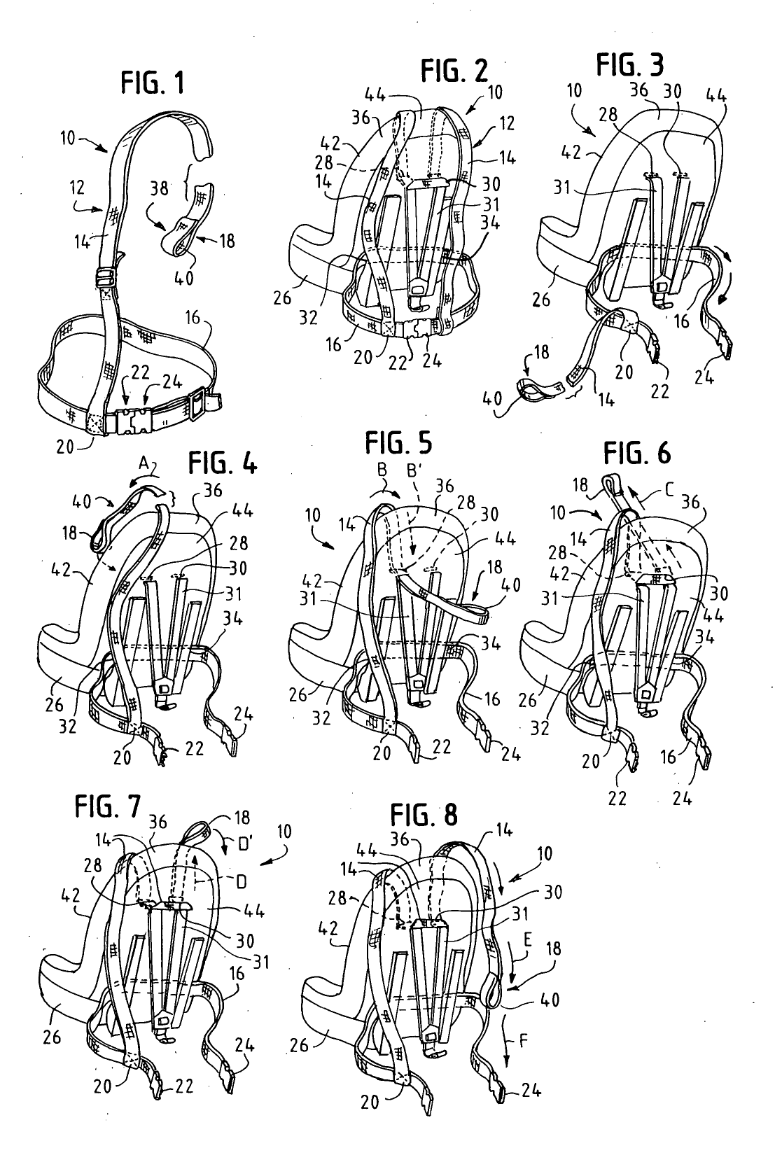

Referring to the Figures generally, where like reference numerals denote like structure and elements, and in particular to FIG. 1, a car seat transport device 10 is shown. Car seat 10 includes a harness 12 with an upper strap 14 and a lower strap 16. Straps 14 and 16 each have respective strap ends, first end 18 of upper strap 14, second end 20 of upper strap 14, first end 22 of lower strap 16 and second end 24 of lower strap 16. FIG. 1 shows a fragmentary perspective view of upper strap 12. It is understood that the length of upper strap 14 may be varied as desired. Straps 14 and 16 may be made of any flexible material with adequate strength to support a car seat as commonly known in the art. Nonlimiting examples of suitable materials for straps 14 and 16 include fabric, textile material, cloth, polymer mesh, nylon webbing, polypropylene webbing, nylike webbing and the like.

As shown in FIG. 2, straps 14 and 16 are adapted to extend through respective slots of a car seat 26. Car seat 26 may be any vehicle safety seat, typically used for the protection of children and infants, that is utilized during transit in a car, a truck, a train, a bus, a ship or an airplane, as is commonly known in the art. Car seat 26 typically has a hard outer shell made of a molded plastic or polymeric material, the interior of which is lined or otherwise covered with padding. Nonlimiting examples of car seat 26 may include a child seat, an infant seat, a booster seat, a forward or rear facing safety seat, and the like.

Car seat 26 includes holes or upper slots 28 and 30 in the molded plastic and padding material through which a safety strap 31 extends to secure a child or infant within the car seat as is commonly known in the art. Car seat 26 also includes lower slots 32 and 34 in the molded plastic back through which a vehicle (i.e., car, truck, bus, airplane, etc.) seatbelt or similar safety strap may be extended in order to secure the car seat to the vehicle or a seat of the vehicle. The skilled artisan will appreciate that the size, number, and shape of slots 28, 30, 32, and 34 may vary based on the size, shape, design and model of car seat 26.

In an embodiment, an end, such as first end 18 of upper strap 14 is adapted to extend or otherwise extends through either upper slot 28 or 30. Upper strap 14 further extends over upper portion 36 of car seat 26 and is attached to lower strap 16. Second end 20 of upper strap 14 is also attached to lower strap 16. Ends 22 and 24 are similarly attached to each other to provide a harness configuration about the car seat that thereby enables a person the ability to transport or otherwise carry car seat 26 from the person's body. In an embodiment, upper strap 14 may extend over a person's shoulder once first end 18 is threaded through slot 28 or 30. End 18 may then be attached to lower strap 16. Lower strap 16 may then be placed or otherwise extended around the person's waist. This configuration of harness 12 about car seat 26 enables the body or the torso of the person to support car seat 26 with the threading of a single upper slot. Car seat 26 may be supported from the front, side or back or the person's body as desired. In an embodiment, car seat 26 is supported from the person's back. Car seat transport device 10 thereby advantageously provides hands-free transport of car seat 26.

Shown in FIG. 1, each strap 14 and 16 has a length that may be adjusted, either increased or decreased, as is commonly known in the art. Nonlimiting examples of suitable length adjustment mechanisms include tri-glide type buckles and hook-and-loop closures. In an embodiment, upper strap 14 may be about 8 feet long and may be adjustable in length from about 1 foot to about 8 feet. In a further embodiment, lower strap 16 may be about 4 feet in length and may be adjustable from about six inches to about 4 feet in length. In a further embodiment, upper strap ends 18 and 20 may be releasably attachable to lower strap 16. Similarly, lower strap ends 22 and 24 may be releasably attachable to each other.

In an embodiment, one or both upper strap ends 18 and 20 may include an attachment member 38 for releasably attaching to lower strap 16. Correspondingly, lower strap 16 may include a reciprocal attachment member that operates in cooperation with attachment member 38 to provide releasable attachment between upper strap ends 18, 20 and lower strap 16. Nonlimiting examples of attachment member 38 and reciprocal attachment member may include a loop, hook and loop material (VELCRO®), a button, a slot, a snap, a zipper, a buckle, male-female attachment, and combinations thereof. In an embodiment, ends 18 and 20 attach to lower strap 16 proximate to ends 22 and 24. In further embodiment, first upper strap end 18 includes attachment member 38 that is a loop 40 as shown in FIGS. 1-10. In yet a further embodiment, harness 12 is a single strap with second upper strap end 20 fixedly attached to lower strap 16.

In an embodiment, first and second ends 22, 24 of lower strap 16 may be releasably attached to each other. Nonlimiting examples of the receasable attachment between ends 22 and 24 may include hook and loop material (VELCRO®), a button and a slot, a snap, a zipper, a buckle, male-female attachment, tongue and slot arrangement (i.e., a belt buckle) and combinations thereof. In an embodiment, end 22 is a male attachment and end 24 is a female attachment to provide belt-buckle type releasable attachment between ends 22 and 24.

In an embodiment, upper strap end 18 extends through or is otherwise threaded through one of slots 28, 30 and extends over the person's shoulder as previously discussed. One of lower strap ends 22, 24 is adapted to extend or otherwise extends through one or both of lower slots 32, 34. Upper strap ends 18 and 20 are then attached to lower strap 16 and lower strap ends 22, 24 are attached to each other, enabling harness 12 to support car seat 26 from the person's body. Lower strap 16 threaded through one or both lower slots 32, 34 advantageously provides stability to car seat 26 suspended from the person's torso. Thus, device 10 may be used to support car seat 26 from a person's back or chest.

In yet another embodiment, second end 20 is attached to lower strap 16. Second end 20 may be releasably attached or fixedly attached to lower strap 16 as desired. First end 18 of upper strap 14 may be moved proximate to upper portion 36 of car seat 26 as shown by arrow A in FIG. 4. First end 18 may then be inserted through first upper slot 28 from seat side 42 of the car seat to shell side 44 of the car seat as shown by arrows B and B′ in FIG. 5. First end 18 may then be subsequently moved along shell side 44 to second upper slot 30. First end 18 may then be inserted or otherwise threaded through upper slot 30 from shell side 44 out to seat side 42 as shown by arrow C in FIG. 6. First end 18 of upper strap 14 may then be moved upward along seat side 42 to extend along and over upper portion 36 as shown by arrows D and D′ in FIG. 7. First end 18 may then be moved or otherwise pulled downward as shown by arrow E in FIG. 8 moving upper strap 14 through slots 28 and 30. First end 18 may then be attached to lower strap 16. This oscillating or alternating threading movement of first end 18 through upper slots 28 and 30 results in upper strap 14 being weaved through upper slots 28 and 30. This opposing threading movement of first end 18 in and out of slots 28 and 30 from the seat side to the shell side and back, interlaces, loops, winds, intertwines, wraps, or otherwise weaves upper strap 14 about car seat 26 to securely fasten the car seat to upper strap 14. In addition, this weaving of upper strap 14 from seat side 42 to shell side 44 through slot 28 and back through slot 30 advantageously forms two shoulder straps as shown in FIG. 8. Thus a single strap, upper strap 14, provides two shoulder straps as a result of the weaving procedure previously described. Lower strap 16 may or may not extend through lower slots 32 and 34.

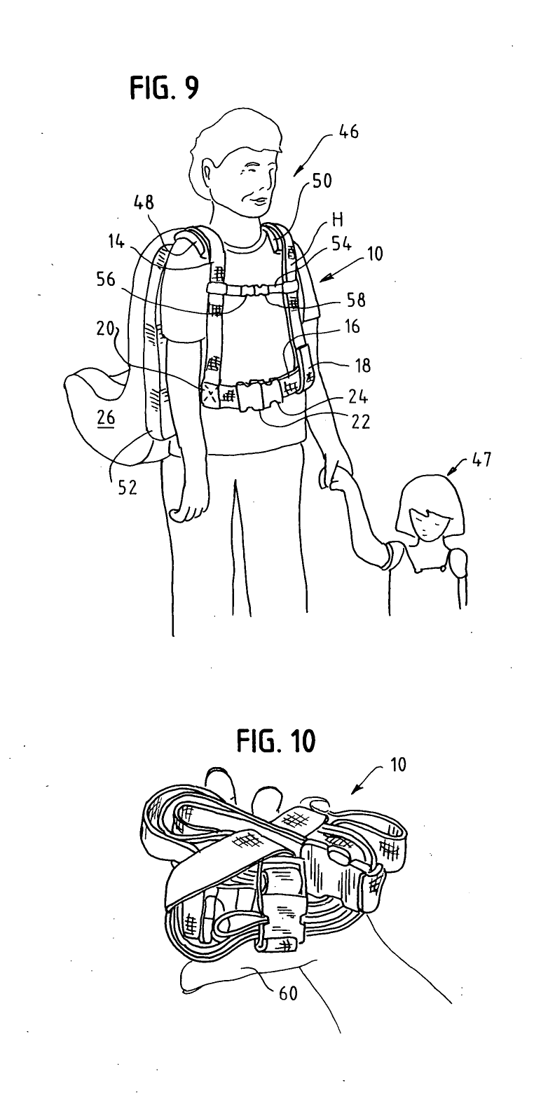

A person 46 may then secure end 18 to lower strap 16, insert an arm through each formed shoulder strap and secure lower strap 16 about the waist to support or otherwise suspend car seat 26 from the person's body as shown in FIG. 9. In an embodiment, an end, such as second end 24 of lower strap 16 may be inserted through one or both lower slots 32, 34 as shown by arrow F in FIG. 8. Threading or extending lower strap 16 through one or both lower slots 32, 34 provides additional stability when car seat 26 is suspended from the person's body. Thus, device 10 enables hands-free transport of car seat 26 with shell side 44 contacting the back of person 46 as shown in FIG. 9.

In an embodiment, car seat transport device 10 further includes shoulder pads 48 and 50, back pad 52 and chest strap 54 for additional comfort and stability to person 46 when carrying car seat 26. Pads 48, 50 and 52 may be made of any resilient compressible material as commonly known in the art. The material of shoulder pads 48, 50 and back pad 52 may be the same or different. In an embodiment, shoulder pads 48 and 50 may be adjustable and may be placed on the rear shoulder, mid-shoulder, or front shoulder as desired. Chest strap 54 may be releasably attachable to upper strap 14, such as by way of a clip-on attachment member or hoop and loop material, for example. Chest strap 54 may also include ends 56 and 58 that may be releasably attachable to each other. The length of chest strap may also be adjustable as is commonly known in the art. In an embodiment, chest strap 54 may be looped around the two substantially vertical upper strap portions of strap 14 that extend from the person's shoulder to lower strap 16 as shown in FIG. 9. The inward tension imparted by chest strap 54 onto the front vertical portions of upper strap 14 advantageously maintains upper strap 14 on the shoulders of person 46.

In an embodiment, device 10 includes harness 12 that has only upper strap 14 and lower strap 16 as support elements for car seat 26. Back and shoulder pads may optionally be added as desired. Device 10 thereby advantageously provides just a single strap for supporting the car seat from the person's body.

Car seat transport device 10 provides a compact, portable, lightweight, foldable, easy to use, support system that may be adapted to carry any type of car seat. Device 10 advantageously allows for hands-free transport of car seat 26 allowing person 46 to escort child 47 by hand, for example. Device 10 is compact and may be folded down to a size dimension of about 2 inches by about 4 inches by about 8 inches, and readily fits into a person's hand 60 as shown in FIG. 10. This compactness enables device 10 to be readily stored or stowed in a suitcase, a glove box, a travel carry-on bag, a diaper bag, a fanny pack, a purse, or the like. Device 10 may even be stowed in a small pouch that may be attached to the car seat itself.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A car seat transport device comprising:
a harness having a lower strap and an upper strap, each strap having respective first and second ends,
the lower strap adapted to extend through a lower slot in the car seat,
the upper strap adapted to extend through an upper slot in the car seat,
the first and second ends of the upper strap attachable to the lower strap, and
the first and second ends of the lower strap attachable to each other.

2. The device of claim 1 wherein the lower strap extends around a person's waist.

3. The device of claim 1 wherein the upper strap extends over a shoulder of a person.

4. The device of claim 1 wherein the harness supports the car seat on a person's back.

5. The device of claim 1 wherein the upper and lower straps each have a length, the length of each strap being adjustable.

6. The device of claim 1 wherein the lower strap is adapted to extend through a second lower slot in the car seat.

7. The device of claim 1 wherein the upper strap is adapted to extend through a second upper slot in the car seat.

8. The device of claim 7 wherein the upper strap extends over a first shoulder and a second shoulder of a person.

9. The device of claim 1 wherein at least one end of the upper strap is releasably attachable to the lower strap.

10. The device of claim 1 wherein the first lower strap end is releasably attachable to the second lower strap end.

11. A car seat transport device comprising:
a harness with a lower strap and an upper strap, each strap having respective first and second ends,
the first end of the upper strap weaved through a first upper slot and a second upper slot of the car seat, the first and second ends of the upper strap attachable to the lower strap, and
the first and second ends of the lower strap attachable to each other.

12. The device of claim 11 wherein the upper strap extends over the shoulders of a person.

13. The device of claim 12 wherein the harness supports the car seat from an area selected from the group consisting of a person's back, a person's chest, and a person's side.

14. The device of claim 11 wherein the lower strap extends around the waist of a person.

15. The device of claim 11 wherein the lower strap extends through a lower slot in the car seat.

16. A method for transporting a car seat comprising:
providing a harness having a lower strap and an upper strap, each strap having respective first and second ends;
extending the first end of the upper strap through an upper slot of the car seat and over a person's shoulder;
extending the lower strap around the person's waist;
attaching the first and second ends of the upper strap to the lower strap;
attaching the first and second ends of the lower strap to each other; and
supporting with the straps the car seat from the person's body.

17. The method of claim 16 further comprising extending an end of the lower strap through a lower slot of the car seat.

18. The method of claim 16 further comprising weaving the first end of the upper strap through a second upper slot of the car seat and extending the upper strap over a second shoulder of the person.

19. The method of claim 16 further comprising extending the first end of the upper strap over an upper portion of the car seat.

20. The method of claim 16 further comprising suspending with the straps the car seat from an area selected the group consisting of the back of the person, the chest of the person, and the side of the person.
